(19) United States
(12) Patent Application Publication
(10) Pub. No.: US 2003/0062111 A1
(43) Pub. Date: Apr. 3, 2003

(54) Method of manufacturing glass ceramic multilayer substrate

(76) Inventor: Yoichi Moriya, Omihachiman-shi (JP)

Correspondence Address: DICKSTEIN SHAPIRO MORIN & OSHINSKY LLP, Edward A. Meilman, 41st Floor, 1177 Avenue of the Americas, New York, NY, 10036-2714, US

(21) Appl. No.: 10/259,512

(22) Filed: Sep. 30, 2002

(30) Foreign Application Priority Data
Sep. 28, 2001 (JP) 2001-300218

(51) Int. Cl. C03B 29/00

(52) U.S. Cl. 156/89.12

(57) ABSTRACT

A green laminate for obtaining a multilayer substrate includes base material layer green sheets held between constraint layer green sheets. The green laminate includes constraint layer green sheets laminated on the outside of a laminate of base material layer green sheets, and cutting grooves are formed in the constraint layer green sheets. By burning the green laminate to obtain a sintered laminate, the difference between expansion and shrinkage behaviors due to the difference between the thermal expansion coefficients of the glass ceramic sintered layer and the ceramic powder fixed layer occurs in each of the regions divided by the cutting grooves, thereby relieving stress due to the difference between expansion and shrinkage behaviors.

### BACKGROUND OF THE INVENTION

1. Field of the Invention

The present invention relates to a method of manufacturing a glass ceramic multilayer substrate, and particularly to a method of manufacturing a glass ceramic multilayer substrate comprising a burning step performed while suppressing shrinkage in a planar direction.

2. Description of the Related Art

In manufacturing a multilayer substrate comprising wiring conductors such as planar conductive patterns, via-hole conductors, etc., the wiring conductors are subjected to a burning step. When using a low-resistance conductor such as Ag, Cu or the like as the wiring conductors, therefore, the multilayer substrate must be formed by using a material which can be sintered at relatively low temperature. As the substrate satisfying this condition, a glass ceramic multilayer substrate has been brought into practical use.

The glass ceramic multilayer substrate comprising a low-resistance conductor such as Ag, Cu or the like, as a wiring conductor is manufactured through the steps of mixing a mixed powder containing a glass powder and a ceramic powder with a resin and a solvent to obtain a slurry, forming the slurry into a sheet to form a green sheet, printing conductive paste containing, as a conductive component, a low-resistance conductor such as Ag or Cu on the green sheet to form a wiring conductor, laminating a plurality of green sheets to obtain a green laminate, and then burning the laminate.

In the burning step, however, the conductive paste and the green sheets exhibit different behaviors of burning shrinkage, and the metal component contained in the conductive paste diffuses into glass contained in the green sheets to cause a change in the shrinkage behavior of glass around the wiring conductors, causing difficulties in manufacturing a glass ceramic multilayer substrate without curvature, i.e., the flat glass ceramic multilayer substrate.

Also, the burning shrinkage of the glass ceramic multilayer substrate is not necessarily constant due to variations in quality of the raw materials used, variations in the material mixing ratio of the slurry at the time of formation of the green sheet, variations in the pressure at the time of formation of the green laminate, etc. Under these conditions, a positional shift of a planar conductive pattern formed on the outer surface of the glass ceramic multilayer substrate occurs frequently. For example, when microelectronic parts are mounted by a flip chip mounting method, the dimensional error exceeds the permissible range, thereby deteriorating yield.

There is thus a demand for realization of a technique for manufacturing a glass ceramic multilayer substrate which is capable of decreasing the burning shrinkage of the glass ceramic multilayer substrate in the planar direction.

According to this demand, Japanese Unexamined Patent Application Publication No. 4-243978 proposes the following method of manufacturing a glass ceramic multilayer substrate. Namely, a glass ceramic multilayer substrate is manufactured by the method in which a plurality of base material layers each comprising a glass power and a ceramic powder as solid components are laminated to form a green laminate, and a constraint layer green sheet which comprises a ceramic powder as a solid component and which is not sintered at the sintering temperature of the base material layer green sheets is laminated on both or one of the surfaces of the green laminate, and then the laminate is burned to shrink only in the thickness direction while suppressing shrinkage in the planar direction of the laminate. This method is consequently capable of manufacturing a glass ceramic multilayer substrate without curvature, i.e., a flat glass ceramic multilayer substrate.

In the above-described manufacturing method, the constraint layer green sheet laminated on both or one of the surfaces of the green laminate is peeled off after burning, and is thus unnecessary for the glass ceramic multilayer substrate as a product. Therefore, the cost for producing the constraint layer green sheet, and the cost for separating the constraint layer green sheet are added to the manufacturing cost of the glass ceramic multilayer substrate, thereby increasing the manufacturing cost of the glass ceramic multilayer substrate.

On the other hand, U.S. Pat. No. 5,102,720 discloses a method of manufacturing a sintered glass ceramic multilayer substrate comprising laminating a plurality of base material layer green sheets, laminating a constraint layer green sheet comprising a ceramic powder as a solid component which is not sintered at the sintering temperature of the base material layer green sheets on a surface of the laminate of the base material layer green sheets to obtain a green laminate, and then burning the green laminate.

In the burning step of this method, the glass component contained in the base material layer green sheets permeates into the constraint layer green sheet to firmly fix the ceramic powder contained in the constraint layer green sheet. Therefore, the ceramic powder fixed layer obtained by the constraint layer green sheet can also be used as a part of the glass ceramic multilayer substrate without being removed after burning.

This method is the same as the method of manufacturing the glass ceramic multilayer substrate disclosed in Japanese Unexamined Patent Application Publication No. 4-243978 in that shrinkage in the planar direction is suppressed by the action of the constraint layer green sheet to permit the manufacture of a glass ceramic multilayer substrate without curvature, i.e., a flat glass ceramic multilayer substrate.

A method of manufacturing a glass ceramic multilayer substrate with less shrinkage in the planar direction is also disclosed in Japanese Unexamined Patent Application Publication Nos. 6-97656 and 6-172017. These publications disclose a method in which first and second base material layer green sheets which are sintered in the burning step but have different thermal shrinkage behaviors are laminated to form a green laminate, and then the green laminate is burned to manufacture a flat glass ceramic multilayer substrate with shrinkage suppressed in the planar direction.

In the method of manufacturing a glass ceramic multilayer substrate disclosed in U.S. Pat. No. 5,102,720, however, the solid component contained in the base material layer green sheets is different from the solid component contained in the constraint layer green sheet, and thus the glass ceramic sintered layers resulting from the base material layer green sheets and the ceramic powder fixed layer resulting from the constraint layer green sheet have different thermal expansion coefficients. Therefore, when the planar dimensions of the sintered laminate obtained by burning the green laminate comprising the base material layer green sheets and the constraint layer green sheet are increased, the glass ceramic sintered layers and the ceramic powder fixed layer become separated from each other at the interface therebetween or microcracks occur due to the difference between the thermal expansion coefficients.

In the method of manufacturing the glass ceramic multilayer substrate disclosed in Japanese Unexamined Patent Application Publication Nos. 6-97656 and 6-172017, it is difficult or substantially impossible for the first glass ceramic sintered layers resulting from the first base material layer green sheets and the second glass ceramic sintered layers resulting from the first base material layer green sheets to have exactly the same thermal expansion coefficient.

Therefore, when the planar dimensions of the sintered laminate are increased, the first glass ceramic sintered layers resulting from the first base material layer green sheets and the second glass ceramic sintered layers resulting from the second base material layer green sheets separate from each other at the interfaces therebetween or microcracks occur due to the difference between the thermal expansion coefficients causing different thermal shrinkage behaviors during burning, like in the method of manufacturing the glass ceramic multilayer substrate disclosed in U.S. Pat. No. 5,102,720.

### SUMMARY OF THE INVENTION

Accordingly, it is an object of the present invention to provide a method of manufacturing a glass ceramic multilayer substrate capable of solving the above problem.

In a first aspect of the present invention, a method of manufacturing a glass ceramic multilayer substrate comprises the first step of forming a base material layer green sheet containing a glass powder and a first ceramic powder as solid components, the second step of forming a constraint layer green sheet which contains a second ceramic powder as a solid component and which is not sintered at the sintering temperature of the base material layer green sheet, the third step of forming at least one of a planar conductive pattern and a via-hole at least in the base material layer green sheet, and the fourth step of laminating a plurality of base material layer green sheets and at least one constraint layer green sheet on at least one surface of a laminate of the base material layer green sheets in the lamination direction to obtain a green laminate.

The present invention is characterized by further comprising the fifth step of forming a cutting groove in the constraint layer green sheet on the green laminate, and the sixth step of burning the green laminate having the cutting groove at the sintering temperature of the base material layer green sheets to obtain a sintered laminate. In the fifth step, the cutting groove is preferably formed to such a depth that it reaches at least the surface of the base material layer green sheets.

In the sixth step, a sintered glass ceramic layer is produced in each of the base material layer green sheets, and the glass component as the solid component in the base material layer green sheets partially or entirely moves into the entirety of the constraint layer green sheet to produce a ceramic powder fixed layer comprising the fixed second ceramic powder. Therefore, the ceramic powder fixed layer is used as a part of the glass ceramic multilayer substrate.

At least one of the planar conductive pattern and the via-hole conductor may be formed in the constraint layer green sheet as well as the base material layer green sheets in the third step.

The constraint layer green sheet is preferably laminated on each surface of the laminate of the base material layer green sheets in the lamination direction thereof instead of being laminated on only one surface in the fourth step.

A general method used for manufacturing a multilayer substrate comprises producing a collective substrate comprising a plurality of multilayer substrates, and then dividing the collective substrate to effectively obtain a plurality of multilayer substrates. In the present invention, when the sintered laminate obtained in the sixth step is in a collective substrate state, the cutting groove is preferably formed in the fifth step so as to function as a cutting groove for dividing the collective substrate. In this case, the method of manufacturing the glass ceramic multilayer substrate of the present invention further comprises the step of dividing the sintered laminate along the cutting groove.

The glass powder contained in the base material layer green sheets comprises, for example, BaO—MgO—SiO₂—B₂O₃ based glass, and the first ceramic powder comprises, for example, alumina or spinel.

The second ceramic powder contained in the constraint layer green sheet comprises, for example, alumina or zirconia.

As described above, the present invention is characterized by forming the cutting groove in the constraint layer green sheet on the green laminate. When the glass ceramic sintered layers and the ceramic powder fixed layer have different thermal expansion coefficients, the influence of the difference between the thermal expansion coefficients is exerted on the surfaces of the sintered laminate if the cutting groove is not formed.

More specifically, when the sintered laminate has a Lm-square planar shape, the difference between the thermal expansion coefficients of the glass ceramic sintered layers and the ceramic powder fixed layer is Δα (ppm/° C.), the lower temperature of the strain point of glass remaining in the glass ceramic sintered layers and the strain point of glass present in the ceramic powder fixed layer is T (° C.), and room temperature is Tr (° C.), the difference between expansion shrinkage behaviors represented by the following formula is produced at the comers of the sintered laminate.

(T−Tr)·Δα·Lm/2^{½}

Therefore, peeling or microcracking frequently occurs in the interfaces between the glass ceramic sintered layers and the ceramic powder fixed layer near the surfaces of the sintered laminate. For example, as described above, when the sintered laminate is in the collective substrate state, peeling or cracking easily occurs in a glass ceramic multilayer substrate obtained from a portion of the sintered laminate near the surfaces thereof.

When the cutting groove is formed, however, the difference between the expansion and shrinkage behaviors due to the difference Δα between the thermal expansion coefficients occurs in each of the regions divided by the cutting groove. If the each of the regions divided by the cutting groove has a Ls square, the difference between the expansion and shrinkage behaviors due to the difference Δα between the thermal expansion coefficients, which occurs at a corner of the sintered laminate, is decreased to Ls/Lm as compared with the case in which the cutting groove is not formed. Therefore, even if the glass ceramic sintered layers and the ceramic powder fixed layer have a slight difference between the thermal expansion coefficients, a glass ceramic multilayer substrate causing neither peeling nor cracking in the interfaces between these layers can be manufactured.

In order to completely exhibit the function of the cutting groove, as described above, the cutting groove is preferably formed to such a depth that it reaches at least the surface of the base material layer green sheets, and thus the constraint layer green sheet is completely divided by the cutting groove.

According to the same principles as the first aspect of the present invention, the present invention can also be applied to the following aspect. Namely, a green sheet corresponding to the constraint layer green sheet in the first aspect is not used in the second aspect of the present invention, but two types of base material layer green sheets which are sintered in the burning step and which have different thermal shrinkage behaviors are used.

In further detail, a method of manufacturing a glass ceramic multilayer substrate in the second aspect of the present invention comprises the first step of producing a first base material layer green sheet containing a glass powder and a ceramic powder as solid components, the second step of producing a second base material layer green sheet containing a glass powder and a ceramic powder as solid components and having a different thermal shrinkage behavior from the first base material layer green sheet, the third step of forming at least one of a planar conductive pattern and a via-hole conductor in the first and second base material layer green sheets, and the fourth step of laminating a plurality of the first base material layer green sheets and at least one second base material layer green sheet on at least one surface of the a laminate of the first base material layer green sheets in the lamination direction to obtain a green laminate. The present invention is characterized by further comprising the fifth step of forming grooves in the second base material layer green sheet on the green laminate, and the sixth step of burning the green laminate having the cutting grooves to obtain a sintered laminate.

In the second aspect of the present invention, substantially the same preferred conditions as the first aspect of the present invention can be used. Namely, the cutting grooves are preferably formed in the fifth step to such a depth that they reach at least the surface of the first base material layer green sheets. Also, the second base material layer green sheet is preferably laminated on each surface of the laminate of the first base material layer green sheets in the lamination direction instead of being laminated on only one surface in the fourth step.

When the sintered laminate obtained in the sixth step is in a collective substrate state, the cutting grooves are preferably formed in the fifth step so as to function as cutting grooves for dividing the collective substrate. In this case, the present invention further comprises the step of dividing the sintered laminate along the cutting grooves.

In the second aspect of the present invention, the first base material layer green sheet and the second base material layer green sheet exhibit different thermal shrinkage behaviors. Examples of a method for exhibiting the different thermal shrinkage behaviors include a method of differentiating the composition of the glass powder contained in the first base material layer green sheet from the composition of the second base material layer green sheet, a method of differentiating the composition of the ceramic powder contained in the first base material layer green sheet from the composition of the second base material layer green sheet, a method of differentiating the compositions of both the glass powder and the ceramic powder contained in the first base material layer green sheet from the compositions of the second base material layer green sheet, a method of differentiating the mixing ratio between the glass powder and the ceramic powder contained in the first base material layer green sheet from the ratio of the second base material layer green sheet, and the like.

### BRIEF DESCRIPTION OF THE DRAWINGS

FIG. 1 is a schematic sectional view schematically showing a glass ceramic multilayer substrate obtained by a manufacturing method according to each of first and second embodiments of the present invention; and

FIGS. 2A to 2E are sectional views schematically showing the typical steps of a method of manufacturing the glass ceramic multilayer substrate shown in FIG. 1.

### DESCRIPTION OF THE PREFERRED EMBODIMENTS

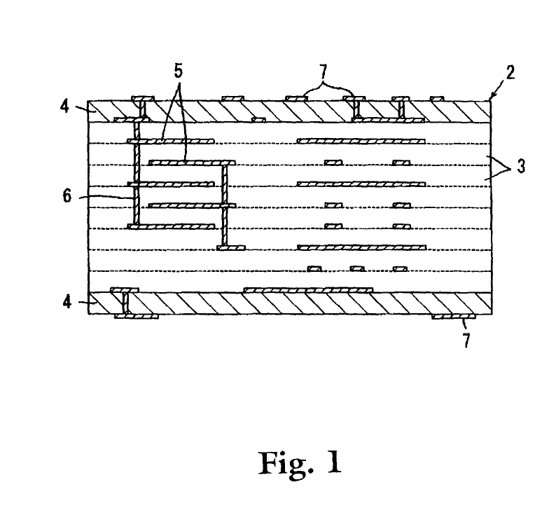

FIG. 1 is a schematic sectional view schematically showing a glass ceramic multilayer substrate 1 obtained by a manufacturing method according to a first embodiment of the present invention.

The glass ceramic multilayer substrate 1 comprises a sintered laminate 2. The sintered laminate 2 comprises a plurality of glass ceramic sintered layers (base material layers) 3, and ceramic powder fixed layers (constraint layers) 4 laminated on both surfaces of a laminate of the glass ceramic multilayer substrate sintered layers 3 in the lamination direction thereof. One or a plurality of the ceramic powder fixed layers 4 may be laminated on each surface in the lamination direction. Also, the ceramic powder fixed layers 4 may be laminated on only one of the surfaces in the lamination direction instead of being laminated on both surfaces as shown in the figure.

Furthermore, various types of wiring conductors are provided on the sintered laminate 2. The wiring conductors include internal planar conductive patterns 5 formed along the interfaces between the respective glass ceramic sintered layers 3 and the interfaces between the glass ceramic sintered layers 3 and the ceramic powder fixed layers 4, and via-hole conductors 6 provided in the sintered laminate 2 so as to pass through the glass ceramic sintered layers 3 or the ceramic powder fixed layers 4.

The wiring conductors further include external planar conductive patterns 7 formed on the outer surfaces of the sintered laminate 2, i.e., on the outer surfaces of the ceramic powder fixed layers 4.

The internal planar conductive patterns 5 and the via-hole conductors 6 function to connect circuit components formed in the glass ceramic multilayer substrate 1, and constitute passive elements such as a capacitor, an inductor, etc. in the sintered laminate 2.

The external planar conductive patterns 7 function as terminal electrodes for electrically connecting other electronic parts mounted on the outer surfaces of the glass ceramic multilayer substrate 1, and terminal electrodes for mounting the glass ceramic multilayer substrate 1 on another wiring substrate.

The glass ceramic multilayer substrate 1 is manufactured as follows.

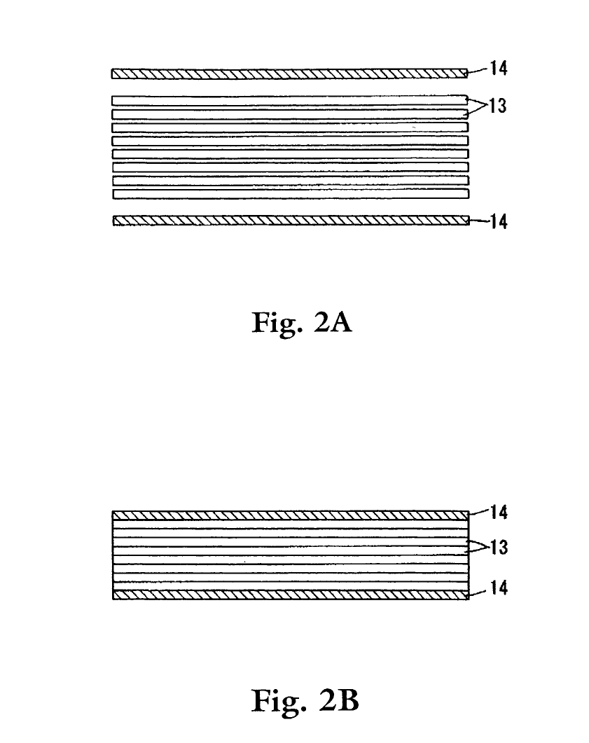

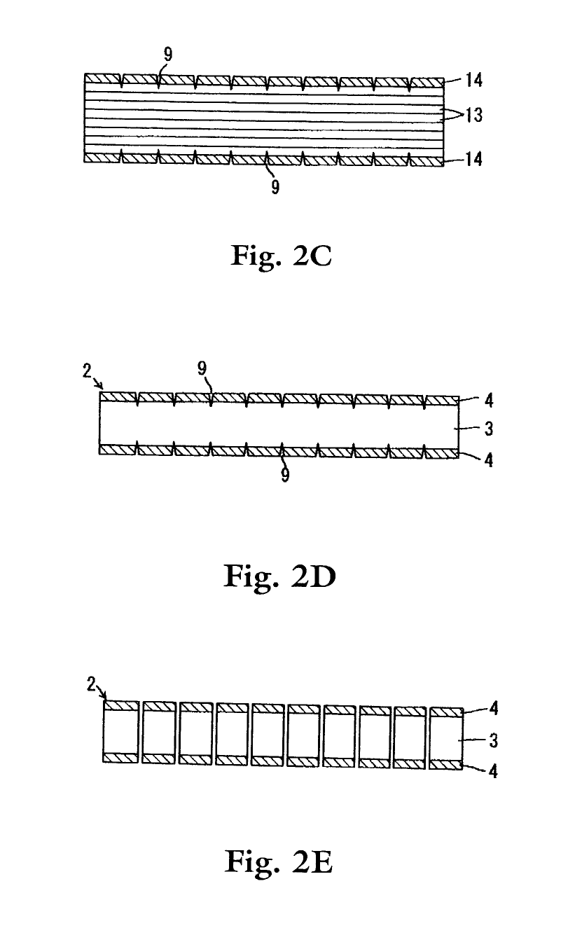

FIGS. 2A through 2E area sectional views schematically showing in turn the steps of the method of manufacturing the glass ceramic multilayer substrate 1.

First, a base material layer green sheet (glass ceramic green sheet) 13 containing a glass powder and a first ceramic powder as solid components is produced, and a constraint layer green sheet 14 which contains a second ceramic powder as a solid component and which is not sintered at the sintering temperature of the base material layer green sheet 13 is produced. The base material layer green sheet 13 and the constraint layer green sheet 14 are produced by, for example, a doctor blade forming method. A plurality of the sheets are stacked as shown in FIG. 2A.

As the glass powder, for example, a powder comprising BaO—MgO—SiO₂—B₂O₃ based glass is used. As the first ceramic powder, for example, a powder of alumina or spinel is used. As the second ceramic powder, for example, a powder of alumina or zirconia is used.

Next, the internal planar conductive patterns 5, the via-hole conductors 6 and the external planar conductive patterns 7 shown in FIG. 1 are formed on the base material layer green sheet 13 and the constraint layer green sheet 14 according to the desired product. In order to form the via-hole conductors 6, through holes are previously provided in each of the base material layer green sheet 13 and the constraint layer green sheet 14. For convenience, the internal planar conductive patterns 5, the via-hole conductors 6 and the external planar conductive patterns 7 are not shown in FIG. 2.

Next, as shown in FIG. 2B, a plurality of the base material layer green sheets 13 are laminated, and the constraint layer green sheet 14 is laminated on each surface of the laminate of the base material layer green sheets 13 in the lamination direction. The laminate is then pressed in the lamination direction to obtain a green laminate 12.

Then, as shown in FIG. 2C, cutting grooves 9 are formed in the constraint layer green sheets on the green laminate 12. The cutting grooves 9 include a first groove and second groove crossing each other at right angles, and each of the first and second grooves comprises a plurality of linear grooves formed in parallel to each other. Namely, the cutting grooves 9 are formed in a planar lattice pattern as viewed from the lamination direction of the laminate 12. The cutting grooves 9 are preferably formed to such a depth that they reach at least the surface of the base material layer green sheets 13, and thus the constraint layer green sheets 14 are completely divided by the cutting grooves 9.

Next, the green laminate 12 having the cutting grooves 9 is burned at the sintering temperature of the base material layer green sheets 13. As a result, as shown in FIG. 2D, a sintered laminate 2 is obtained. The sintered laminate 2 corresponds to the sintered laminate 2 of the glass ceramic multilayer substrate 1 shown in FIG. 1, but is in the collective substrate state. The cutting grooves 9 are provided for dividing along the cutting grooves 9, and dividing along the cutting grooves 9 produces the sintered laminate 2 for each of the glass ceramic multilayer substrates 1 shown in FIG. 1.

In the burning step, the constraint layer green sheets 14 are not sintered substantially, and thus do not shrink substantially. Therefore, the constraint layer green sheets 14 function to suppress shrinkage of the base material layer green sheets 13 during burning, thereby substantially suppressing shrinkage of the base material layer green sheets 13 by the constraint layer green sheets 14 in the planar direction while allowing shrinkage in the thickness direction.

As a result of the burning step, a glass ceramic sintered layer 3 is produced in each of the base material layer green sheets 13. During this step, the glass component as the solid component of the base material layer green sheets 13 partially or entirely moves into the entirety of the constraint layer green sheets 14 to fix the second ceramic powder contained in the constraint layer green sheets 14. Consequently, a ceramic powder fixed layer 4 is formed over the entire portion of each of the constraint layer green sheets 14.

As shown in FIG. 2D, even when the glass ceramic sintered layers 3 and the ceramic powder fixed layers 4 have different thermal expansion coefficients, a good interface bonding property can be obtained in the sintered laminate 2 in the collective substrate state.

This is because in the sintered laminate 2 as described above, the difference between the expansion and shrinkage behaviors due to the difference between the thermal expansion coefficients occurs in each of the regions divided by the cutting grooves 9, thereby relieving stress caused by the difference between the expansion and shrinkage behaviors, as compared with the case in which the cutting grooves 9 are not provided. Therefore, even if the glass ceramic sintered layers 3 and the ceramic powder fixed layers 4 have a slight difference between the thermal expansion coefficients, it is possible to prevent the occurrence of peeling or micro cracking in the interfaces.

Even when the cutting grooves 9 are provided in the constraint layer green sheets 14, the effect of suppressing shrinkage of the base material green sheets 13 by the constraint layer green sheets 14 is substantially not impaired.

The glass ceramic sintered layers 3 and the ceramic powder fixed layers 4 correspond to the glass ceramic sintered layers 3 and the ceramic powder fixed layers 4 of the sintered laminate 2 shown in FIG. 1.

Next, as shown in FIG. 2E, the sintered laminate 2 in the collective substrate state is divided along the cutting grooves 9 into the sintered laminates for respective glass ceramic multilayer substrates I shown in FIG. 1, to obtain a plurality of glass ceramic multilayer substrates.

Although the above-described first embodiment uses a combination of the base material layer green sheet which is sintered in the burning step, and the constraint layer green sheet which is substantially not sintered, a combination of a first base material layer green sheet and a second base material layer green sheet which exhibit different thermal shrinkage behaviors may be used, as described above. A second embodiment will be described with reference to FIGS. 1 and 2.

Referring to FIG. 1, a glass ceramic multilayer substrate 1 comprises a sintered laminate 2. The sintered laminate 2 comprises a plurality of laminated first glass ceramic sintered layers 3, and second glass ceramic sintered layers 4 laminated on both surfaces of the laminate of the first glass ceramic sintered layers 3 in the lamination direction.

Also, internal planar conductive patterns 5 and via-hole conductors 6 are formed in the sintered laminate 2, and external planar conductive patterns 7 are formed on the outer surfaces of the sintered laminate 2.

The glass ceramic multilayer substrate 1 is manufactured as follows.

As shown in FIG. 2A, a first base material layer green sheet 13 containing a glass powder and a ceramic powder as solid components is produced, and a second base material layer green sheet 14 which contains a glass powder and a ceramic powder as solid components and which has a different thermal shrinkage behavior from the first base material layer green sheet 13 is produced, and a stack is assembled.

The first and second base material layer green sheets are different in the composition of the glass powder, the composition of the ceramic powder, the compositions of both the glass powder and the ceramic powder, or the mixing ratio of the glass powder and the ceramic powder, and thus have different thermal shrinkage behaviors.

Next, the internal planar conductive patterns 5, the via-hole conductors 6 and the external planar conductive patterns 7 shown in FIG. 1 are formed in the first and second base material layer green sheets 13 and 14 according to the desired product.

Next, as shown in FIG. 2B, a plurality of the first base material layer green sheets 13 are laminated, and the second base material layer green sheets 14 are laminated on both surfaces of the laminate of the first base material layer green sheets 13 in the lamination direction. The laminate is then pressed in the lamination direction to obtain a green laminate 12.

Then, as shown in FIG. 2C, the cutting grooves 9 are formed in the second base material layer green sheets 14 on the green laminate 12. The cutting grooves 9 are preferably formed to such a depth that they reach at least the surfaces of the first base material layer green sheets 13, and thus the second base material layer green sheets 14 are completely divided by the cutting grooves 9.

Next, the green laminate 12 having the cutting grooves 9 is burned. As a result, as shown in FIG. 2D, the first and second base material layer green sheets 13 and 14 are sintered to obtain a sintered laminate 2.

Next, dividing along the cutting grooves 9 produces the sintered laminates 2 for respective glass ceramic multilayer substrates 1 shown in FIG. 1.

In the burning step, the first and second base material layer green sheets 13 and 14 exhibit different thermal shrinkage behaviors, and thus function to suppress shrinkage by each other, thereby obtaining the sintered laminate 2 with substantially no shrinkage in the planar direction.

In the sintered laminate 2 in the collective substrate state, as shown in FIG. 2D, even when the first and second glass ceramic sintered layers 3 and 4 have different thermal expansion coefficients, a good interface bonding property can be obtained for the same reason as in the first embodiment, and thus the occurrence of microcracking can be prevented.

The description of the first embodiment can be applied to the second embodiment unless otherwise specified.

Experimental examples carried out for confirming the effect of the present invention will be described below.

1. Example 1 and Comparative Example 1 (corresponding to the first embodiment)

A BaO—MgO—SiO₂—B₂O₃ based glass powder and an alumina powder were mixed at a weight ratio of 80:20 to form a mixed powder as a solid component. An acryl resin, xylene, butanol, a plasticizer and a dispersant were added to the mixed powder and mixed to produce slurry. The thus-obtained slurry was formed into a base material layer green sheet of 100 μm in thickness by using the doctor blade method.

On the other hand, a constraint layer green sheet of 100 μm in thickness was formed by the same operation as the base material layer green sheet except that an alumina powder was used as a solid component.

Next, eight base material layer green sheets were laminated, and one constraint layer green sheet was laminated on each surface in the lamination direction to obtain a green laminate. The resultant green laminate was pressed at a temperature of 100° C. under a pressure of 100 kgf/cm² for 30 seconds. Each of the laminated green sheets has a planar size of 200 mm×200 mm.

### Comparative Example 1

In comparative example 1, the green laminate was burned in the air under a burning condition in which it was heated at a heating rate of 10° C./min and maintained at a maximum temperature of 900° C. for 30 minutes, and then cooled at a cooling rate of 10° C./min up to 500° C. and slowly cooled in a burning furnace from 500° C. to room temperature.

The thus-obtained sintered laminate had a planar size of 196 mm×196 mm.

Next, the sintered laminate was divided into planar sizes of 19.6 mm×19.6 mm by using a glass cutter. In a divided part positioned at a corner of the sintered laminate, peeling occurred in the interfaces between the glass ceramic sintered layers resulting from the base material layer green sheets and the ceramic powder fixed layers resulting from the constraint layer green sheets.

### Example 1

On the other hand, in example 1, cutting grooves having a depth of 150 μm were formed in a lattice shape in the constraint layer green sheets on the green laminate so as to extend in the longitudinal and lateral directions with intervals of 20 mm, and then the green laminate was burned under the same conditions as Comparative Example 1.

After dividing of the thus-obtained sintered laminate along the cutting grooves, no peeling was observed even in the divided part positioned at a comer of the sintered laminate. When observation of a section of the divided part by a scanning electron microscope (SEM) was performed, no cracking was observed.

2. Example 2 and Comparative Example 2 (corresponding to the first embodiment)

The same operation as Example 1 and Comparative Example 1 was carried out except that a zirconia powder was used as the solid component of the constrained green sheet to obtain a green laminate.

### Comparative Example 2

In Comparative Example 2, the green laminate was burned under the same conditions as Comparative Example 1 to form a sintered laminate, and then divided by the same operation as Comparative Example 1 to obtain divided parts from the sintered laminate.

In the divided part, peeling occurred between the glass ceramic sintered layers and the ceramic powder fixed layers at a comer of the sintered laminate.

### Example 2

On the other hand, in Example 2, cutting grooves having a depth of 150 μm were formed in a lattice shape in the constraint layer green sheets on the green laminate so as to extend in the longitudinal and lateral directions with intervals of 20 mm in the same manner as Example 1, and then the green laminate was burned under the same conditions as Comparative Example 2.

After dividing of the thus-obtained sintered laminate, no peeling was observed even in the divided part positioned at a corner of the sintered laminate. No cracking was observed in SEM observation of a section of the divided part.

3. Example 3 and Comparative Example 3 (corresponding to the second embodiment)

Both the glass powder and the ceramic powder contained in the first base material layer green sheet had different compositions from the compositions of the second base material layer green sheet.

Namely, a BaO—MgO—SiO₂—B₂O₃ based glass powder and an alumina powder were mixed at a weight ratio of 80:20 to obtain a mixed powder as a solid component. An acryl resin, xylene, butanol, a plasticizer and a dispersant were added to the mixed powder and mixed to produce slurry. The thus-obtained slurry was formed into a first base material layer green sheet of 100 μm in thickness by using the doctor blade method.

On the other hand, a MgO—ZnO—SiO₂—B₂O₃ based glass powder and a BaO—La₂O₃—Nd₂O₃—TiO₂ based ceramic powder were mixed at a weight ratio of 30:70 to obtain a mixed powder as a solid component. The same operation as the first base material layer green sheet was carried out to form a second base material layer green sheet of 100 μm in thickness.

Next, eight first base material layer green sheets were laminated, and one second base material layer green sheet was laminated on each surface in the lamination direction to obtain a green laminate. The resultant green laminate was pressed at a temperature of 100° C. under a pressure of 100 kgf/cm² for 30 seconds. Each of the laminated green sheets has a planar size of 200 mm×200 mm.

### Comparative Example 3

Next, in Comparative Example 3, the green laminate was burned in the air under a burning condition in which it was heated at a heating rate of 10° C./min and then maintained at a maximum temperature of 900° C. for 30 minutes, and then cooled down at a cooling rate of 10° C./min to 500° C. and slowly cooled in a burning furnace from 500° C. to room temperature. The thus-obtained sintered laminate had a planar size of 195 mm×195 mm.

Next, the sintered laminate was divided into planar sizes of 19.5 mm×19.5 mm by using a glass cutter. In a divided part positioned at a corner of the sintered laminate, peeling occurred in the interfaces between the first glass ceramic sintered layers resulting from the first base material layer green sheets and the second glass ceramic sintered layers resulting from the second base material layer green sheets. Example 3

On the other hand, in Example 3, cutting grooves having a depth of 150 μm were formed in a lattice shape in the second base material layer green sheets on the green laminate so as to extend in the longitudinal and lateral directions with intervals of 20 mm, and then the green laminate was burned under the same conditions as Comparative Example 3.

After dividing of the thus-obtained sintered laminate along the cutting grooves, no peeling was observed even in the divided part positioned at a corner of the sintered laminate. In SEM observation of a section of the divided part, no cracking was observed.

In Example 3 and Comparative Example 3, a powder having the BaO—La₂O₃—Nd₂O₃—TiO₂ based composition was used as the ceramic powder contained in the second base material layer green sheet. However, even when the La₂O₃ in the composition system was changed by another rare earth element oxide, substantially the same result was obtained.

4. Example 4 and Comparative Example 4 (corresponding to the second embodiment)

The glass powder contained in the first base material layer green sheet had a different composition from the composition of the second base material layer green sheet.

Namely, a BaO—MgO—SiO₂—B₂O₃ based glass powder and an alumina powder were mixed at a weight ratio of 80:20 to obtain a mixed powder as a solid component. The same operation as Example 3 and Comparative Example 3 was carried out to form a first base material layer green sheet of 100 μm in thickness.

On the other hand, a SrO—MgO—SiO₂—B₂O₃ based glass powder and an alumina ceramic powder were mixed at a weight ratio of 80:20 to obtain a mixed powder as a solid component. The same operation as the first base material layer green sheet was carried out to form a second base material layer green sheet of 100 μm in thickness.

Next, the same operation as Example 3 and Comparative Example 3 was carried out to form a green laminate.

### Comparative Example 4

In Comparative Example 4, the green laminate was burned under the same conditions as Comparative Example 3. The thus-obtained sintered laminate had a planar size of 168 mm×168 mm.

Next, the sintered laminate was divided into planar sizes of 16.8 mm×16.8 mm by using a glass cutter. In a divided part positioned at a corner of the sintered laminate, peeling occurred in the interface between the first glass ceramic sintered layer resulting from the first base material layer green sheet and the second glass ceramic sintered layer resulting from the second base material layer green sheet.

Example 4

On the other hand, in Example 4, cutting grooves were formed in the second base material layer green sheets on the green laminate in the same manner as Example 3, and then the green laminate was burned under the same conditions as Comparative Example 4.

After dividing of the thus-obtained sintered laminate along the cutting grooves, neither peeling nor cracking was observed even in the divided part positioned at a corner of the sintered laminate.

5. Example 5 and Comparative Example 5 (corresponding to the second embodiment)

The ceramic powder contained in the first base material layer green sheet had a different composition from the composition of the second base material layer green sheet.

Namely, a BaO—MgO—SiO₂—B₂O₃ based glass powder and an alumina powder were mixed at a weight ratio of 80:20 to obtain a mixed powder as a solid component. The same operation as Example 3 and Comparative Example 3 was carried out to form a first base material layer green sheet of 100 μm in thickness.

On the other hand, a BaO—MgO—SiO₂—B₂O₃ based glass powder and a mullite powder were mixed at a weight ratio of 65:35 to obtain a mixed powder as a solid component. The same operation as the first base material layer green sheet was carried out to form a second base material layer green sheet of 100 μm in thickness.

Next, the same operation as Example 3 and Comparative Example 3 was carried out to form a green laminate.

### Comparative Example 5

In Comparative Example 5, the green laminate was burned under the same conditions as Comparative Example 3. The thus-obtained sintered laminate had a planar size of 162 mm×162 mm.

Next, the sintered laminate was divided into planar sizes of 16.2 mm×16.2 mm by using a glass cutter. In a divided part positioned at a corner of the sintered laminate, peeling occurred in the interface between the first glass ceramic sintered layer resulting from the first base material layer green sheet and the second glass ceramic sintered layer resulting from the second base material layer green sheet.

### Example 5

On the other hand, in Example 5, cutting grooves were formed in the second base material layer green sheets on the green laminate in the same manner as Example 3, and then the green laminate was burned under the same conditions as Comparative Example 5.

After dividing of the thus-obtained sintered laminate along the cutting grooves, neither peeling nor cracking was observed even in the divided part positioned at a corner of the sintered laminate.

6. Example 6 and Comparative Example 6 (corresponding to the second embodiment)

The first base material layer green sheet contained the glass powder and the ceramic powder at a ratio different from the second base material layer green sheet.

Namely, a BaO—MgO—SiO₂—B₂O₃ based glass powder and an alumina powder were mixed at a weight ratio of 80:20 to obtain a mixed powder as a solid component. The same operation as Example 3 was carried out to form a first base material layer green sheet of 100 μm in thickness.

On the other hand, the same BaO—MgO—SiO₂—B₂O₃ based glass powder and alumina powder as those contained in the first base material layer green sheet were mixed at a weight ratio of 70:30 to obtain a mixed powder as a solid component. The same operation as the first base material layer green sheet was carried out to form a second base material layer green sheet of 100 μm in thickness.

Next, the same operation as Example 3 and Comparative Example 3 was carried out to form a green laminate.

### Comparative Example 6

In Comparative Example 6, the green laminate was burned under the same conditions as Comparative Example 3. The thus-obtained sintered laminate had a planar size of 172 mm×172 mm.

Next, the sintered laminate was divided into planar sizes of 17.2 mm×17.2 mm by using a glass cutter. In a divided part positioned at a corner of the sintered laminate, peeling occurred in the interface between the first glass ceramic sintered layer resulting from the first base material layer green sheet and the second glass ceramic sintered layer resulting from the second base material layer green sheet.

### Example 6

On the other hand, in Example 6, cutting grooves were formed in the second base material layer green sheets on the green laminate in the same manner as Example 3, and then the green laminate was burned under the same conditions as Comparative Example 6.

After dividing of the thus-obtained sintered laminate along the cutting grooves, neither peeling nor cracking was observed even in the divided part positioned at a corner of the sintered laminate.

Although the specified embodiments of the present invention are described above, various modified embodiments can be made within the scope of the present invention.

Although, the cutting grooves 9 in the first and second embodiments are formed to a depth to reach the surface of the base material layer green sheet 13, for example, the cutting grooves may be formed to partially leave the thickness of the constraint layer green sheet or the second base material layer green sheet as long as the effect of the cutting grooves is substantially exhibited.

In the first embodiment, the planar conductive patterns 5 and 7 and the via-hole conductors 6 are also formed in the constraint layer green sheets 14 laminated on both surfaces in the lamination direction. However, in another embodiment, when the constraint layer green sheets 14 are laminated on both surfaces in the lamination direction, the planar conductive pattern and the via-hole conductor may be formed in one of the constraint layer green sheets 14.

Although, the constraint layer green sheets 14 in the first embodiment are laminated on both surfaces in the lamination direction, the constraint layer green sheet 14 may be laminated on only one surface in the lamination direction. This applies to the second base material layer green sheets 14 of the second embodiment.

Although, the cutting grooves 9 in the first and second embodiments serve as grooves for dividing the sintered laminate 2 in the collective substrate state, the cutting grooves may be left in the glass ceramic multilayer substrate without functioning as grooves for division. Also, the groove pattern need not be symmetrical.

The present invention can also be applied to cases other than the case in which two types of green sheets are laminated for suppressing shrinkage in the planar direction during burning like in a conventional technique. When shrinkage in the planar direction during burning cannot be prevented, any method of manufacturing a glass ceramic multilayer substrate comprising laminating two types of green sheets causes the problem of a difference between thermal expansion coefficients. Therefore, the present invention can be applied to such a case. For example, the present invention can be applied to a method of manufacturing a glass ceramic multilayer substrate comprising a combination of a low dielectric constant material and a high-strength material, as disclosed in Japanese Unexamined Patent Application Publication No. 10-194828.

As described above, in the first aspect of the present invention, a plurality of base material layer green sheets are laminated, and at least one constraint layer green sheet is laminated on at least one surface of the laminate of the base material layer green sheets in the lamination direction to obtain a green laminate, and cutting grooves are formed in the constraint layer green sheet of the green laminate.

Therefore, in the sintered laminate obtained by sintering the green laminate at the sintering temperature of the base material layer green sheets, even when the glass ceramic sintered layers resulting from the base material layer green sheets and the ceramic powder fixed layer resulting from the constraint layer green sheet have different thermal expansion coefficients, the difference in expansion shrinkage behaviors due to the difference between the thermal expansion coefficients occurs in each of the regions divided by the cutting grooves. Therefore, the stress caused by the difference between the expansion shrinkage behaviors can be relieved.

As a result, a good bonding property can be obtained between the glass ceramic sintered layer and the ceramic powder fixed layer, and a glass ceramic multilayer substrate with suppressed cracking or the like can be manufactured.

This effect is particularly significantly exhibited when the sintered laminate is in a collective substrate state, i.e., when the sintered laminate has a relatively large planar size. In this case, when the sintered laminate is divided along the cutting grooves to obtain respective glass ceramic multilayer substrates, the cutting grooves formed for relieving stress due to the difference between the expansion shrinkage behaviors can also be used as division grooves.

Also, when the cutting grooves are formed to such a depth that they reach the surface of the base material layer green sheet, the above-described effect can be brought into further perfection.

In the green laminate, at least one constraint layer green sheet is laminated on each surface of the laminate of the base material layer green sheets in the lamination direction in one embodiment, and thus the function to suppress shrinkage of the base material layer green sheets by the constraint layer green sheets during burning is exhibited with good balance. Thus, a glass ceramic multilayer substrate with less curvature, i.e., a flat glass ceramic multilayer substrate, can easily and securely be manufactured.

In the second aspect of the present invention, substantially the same effects as described above are exhibited. Namely, when a plurality of first base material layer green sheets are laminated, and at least one second base material layer green sheet having a different thermal shrinkage behavior from the first base material layer green sheets is laminated on at least one surface of the laminate of the first base material layer green sheets in the lamination direction to obtain a green laminate, and cutting grooves are formed in the second base material layer green sheet, substantially the same effects as the first aspect are exhibited.

What is claimed is:

1. A method of manufacturing a glass ceramic multilayer substrate comprising:
providing a plurality of base material layer green sheets containing a glass powder and a first ceramic powder as a solid component, at least one of said base material layer green sheets having at least one of a planar conductive pattern thereon or a via-hole conductor therein, or both;
providing at least one constraint layer green sheet which contains a second ceramic powder as a solid component which is not sintered at a sintering temperature of the base material layer green sheets;
forming a green laminate comprising a laminate of a plurality of base material layer green sheets and at least one constraint layer green sheet on at least one surface of the laminate of the base material layer green sheets in the lamination direction;
forming a cutting groove in the constraint layer green sheet on the green laminate; and
burning the green laminate having the cutting groove at the sintering temperature of the base material layer green sheets to obtain a sintered laminate;
whereby during burning, a sintered glass ceramic layer is produced in each of the base material layer green sheets, and a portion of the glass component of the base material layer green sheets at least partially moves into the entirety of the constraint layer green sheet to produce a ceramic powder fixed layer comprising the fixed second ceramic powder.

2. The method of manufacturing a glass ceramic multilayer substrate according to claim 1, wherein the cutting groove is formed to such a depth that the cutting group reaches at least the surface of a base material layer green sheet.

3. The method of manufacturing a glass ceramic multilayer substrate according to claim 1, wherein at least one of a planar conductive pattern and a via-hole conductor is formed on or in the constraint layer green sheet.

4. The method of manufacturing a glass ceramic multilayer substrate according to claim 1, at least one constraint layer green sheet is laminated on each surface of the laminate of the base material layer green sheets in the lamination direction thereof.

5. The method of manufacturing a glass ceramic multilayer substrate according to claim 1, further comprising dividing the sintered laminate along at least one cutting groove.

6. The method of manufacturing a glass ceramic multilayer substrate according to claim 1, wherein the glass powder comprises a BaO—MgO—SiO₂—B₂O₃ glass, and the first ceramic powder comprises at least one of alumina and spinel.

7. The method of manufacturing a glass ceramic multilayer substrate according to claim 1, wherein the second ceramic powder comprises alumina or zirconia.

8. The method of manufacturing a glass ceramic multilayer substrate according to claim 1, wherein the cutting groove is formed in a planar lattice pattern.

9. The method of manufacturing a glass ceramic multilayer substrate according to claim 8, wherein the cutting groove is formed to such a depth that the cutting group reaches at least the surface of a base material layer green sheet, the glass powder comprises a BaO—MgO—SiO₂—B₂O₃ glass, and the first ceramic powder comprises at least one of alumina and spinel; and wherein the second ceramic powder comprises alumina or zirconia.

10. The method of manufacturing a glass ceramic multilayer substrate according to claim 9, further comprising dividing the sintered laminate along at least one cutting groove.

11. A method of manufacturing a glass ceramic multilayer substrate comprising:
providing a plurality of base material layer green sheets containing a glass powder and a first ceramic powder as a solid component, at least one of said base material layer green sheets having at least one of a planar conductive pattern thereon or a via-hole conductor therein, or both;
providing at least one constraint layer green sheet comprising a second base material layer green sheet which contains a glass powder and a ceramic powder as a solid component, the second base material layer green sheet having a different thermal shrinkage behavior than the first base material layer green sheets;
forming a green laminate comprising a laminate of a plurality of base material layer green sheets and at least one constraint layer green sheet on at least one surface of the laminate of the base material layer green sheets in the lamination direction;
forming a cutting groove in the constraint layer green sheet on the green laminate; and
burning the green laminate having the cutting groove therein to obtain a sintered laminate.

12. The method of manufacturing a glass ceramic multilayer substrate according to claim 11, wherein the cutting groove is formed to such a depth that the cutting groove reaches at least the surface of a first base material layer green sheet.

13. The method of manufacturing a glass ceramic multilayer substrate according to claim 11, wherein at least one second base material layer green sheet is laminated on each surface of the laminate of the first base material layer green sheets in the lamination direction.

14. The method of manufacturing a glass ceramic multilayer substrate according to claim 11, further comprising the step of dividing the sintered laminate along at least one cutting groove.

15. The method of manufacturing a glass ceramic multilayer substrate according to claim 11, wherein the first base material layer green sheet and the second base material layer green sheet are different in the composition of at least one of the glass powder and the ceramic powder.

16. The method of manufacturing a glass ceramic multilayer substrate according to claim 11, wherein the first base material layer green sheet and the second base material layer green sheet are different in the relative amounts of the glass powder and the ceramic powder.

17. The method of manufacturing a glass ceramic multilayer substrate according to claim 11, wherein the cutting groove is formed in a planar lattice pattern.

18. The method of manufacturing a glass ceramic multilayer substrate according to claim 17, wherein the cutting groove is formed to such a depth that the cutting groove reaches at least the surface of a first base material layer green sheet.

19. The method of manufacturing a glass ceramic multilayer substrate according to claim 18, further comprising the step of dividing the sintered laminate along at least one cutting groove.

20. The method of manufacturing a glass ceramic multilayer substrate according to claim 19, wherein at least one second base material layer green sheet is laminated on each surface of the laminate of the first base material layer green sheets in the lamination direction.
